(19) United States
(12) Patent Application Publication
(10) Pub. No.: US 2007/0198925 A1
(43) Pub. Date: Aug. 23, 2007

(54) Method and system for editing a multimedia message

(75) Inventors: Dahua He, Shanghai (CN); Yang Peng, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 10/599,820

(22) PCT Filed: Feb. 3, 2005
(86) PCT No.: PCT/IB05/50446

§ 371 Date: Oct. 11, 2006

(30) Foreign Application Priority Data
Apr. 14, 2004 (CN) 2004100346010

(51) Int. Cl. G06F 17/00; G06F 3/048

(52) U.S. Cl. 715/530; 715/764; 715/513; 715/512

(57) ABSTRACT

The present invention provides a method for creating a multimedia information file. At first, obtaining an initial file that is based on the markup language and includes at least two objects, then, receiving a user's choice of one of said at least two objects, and fmally, marking the selected object as one being recommended, making it be preferentially recommended when editing the created file in future. This invention also provides a method for editing a multimedia information file that includes objects with recommended editing marks. This invention can help a common user of mobile phone easily find a object he wants to be modified from many objects in a multimedia information file according to recommended objects. Therefore, this invention facilitates greatly common users of mobile phone to handle multimedia information.

### BACKGROUND OF THE INVENTION

The present invention relates to a method and apparatus for editing files based on markup languages, and particularly relates to a method and apparatus for editing multimedia information files.

Mobile phone messaging services are very popular messaging value-added services, at present whose main operation model is the SMS (Short Messaging Service), and every month, around 30 billion SMS messages are sent globally. The present SMS messages are mostly based on the text information, so editing them appears to be very simple and easy to learn, which in some extent boosts the promotion and popularization of mobile SMS messages.

The latest development of mobile messaging service is MMS (Multimedia Messaging Service), as SMS messaging service, MMS messaging service allows the mobile phone users to send various information, but the content and presentation are much superior to present SMS messaging service. In addition to the text information, simple images and music, the MMS messaging service can also provide rather complicated aud io and video contents and presents the users with elaborated layout.

The MMS messaging service applied on mobile phones is a new messaging value-added service. This service supports multimedia functionality and is developed according to the multimedia messaging part in 3GPP (3^{rd} Generation Partnership Project) standard (3GPP TS 23.140). According to 3GPP standard, multimedia information can be integrated through SMIL (Synchronized Multimedia Integration Language). SMIL is a markup language conformed to XML (eXtensible Markup Language), SMIL not only can integrate various content steams of the multimedia program by time order, but also can be used to manage the layout of the multimedia program when presenting. About the SMIL applications in multimedia messaging service in 3GPP standard, refer to the parts TS26.140 and TS26.234 in the specification of 3GPP standard.

Although SMIL looks simple, but for normal mobile phone users, if they don't have certain bases of computer languages, it is still difficult for them to understand the grammar and definition of SMIL files, and it is even difficult when them want to further edit and modify the files. Even if under the help of dedicated authoring tools, it is till a tough job.

In particular for a handheld apparatus, such as mobile phone, the resources used for editing files are quite limited comparing to personal computer, for example, the input keys of mobile phones are small and less, so complicated operations can't be done conveniently; and the screen of mobile phones is small, so it is difficult to display more multimedia objects. Such reasons further limit the usage of multimedia messaging for normal users. For instance, a mobile phone user accepted a multimedia message, and he likes the message and wants to forward and share it with his friends after proper editing, but because of the limitation of the mobile phone resources and the lack of knowledge about SMIL language, it is very difficult for him to make any editing and modification.

The difficulty of editing multimedia message files on mobile phone can be manifested by the following example. Because 3GPP standard has no limitation to the size of multimedia message files, there can be hundreds or thousands of objects, e.g. 100 objects, in the file. If the user wants to find an object he wants to edit from these 100 objects, it is apparently very difficult to be implemented on mobile phone.

In order to solve the limitation of normal users' lack of knowledge about SMIL language, the present method is to produce plenty of ready multimedia messages in advance or prepare some structural multimedia file templates for users to use. For example, the UK patent application with the publication number GB23862299 (application date: 3^{rd}, September 2002, inventor: Paola Marcella Hobson) disclosed the following technical scheme: dividing a multimedia message into different portions, basically classifying to introduction portion, information portion and ending portion, and each portion can be edited separately, and then composing them to a multimedia message. The multimedia message in this scheme can include certain amount of portions, but if the amount is big, then it will be an troublesome process to find the portion user wants to edit from numerous portions.

Therefore, there exists a need for a new method and apparatus for editing multimedia message files, so that users can conveniently find the object they want to edit from many objects within a multimedia message, especially on resource restricted apparatus such as handheld apparatus.

### DISCLOSURE OF THE INVENTION

One object of the present invention is to eliminate the defects of current editing method and apparatus for multimedia message files and provide a new editing method and apparatus for multimedia message files, so that users can conveniently find the object they want to edit from many objects within a multimedia message.

The present invention provides a method for generating a markup language-based file. Firstly, obtain an initial file, which is based on said markup language, and the file includes at least two objects; secondly, accept one of the objects chosen by the user from said at least two objects; lastly, mark the chosen object to be recommended, so that the chosen object will be preferable recommended in the future when editing the generated file. Said step of marking is to insert a tag into the file. Said file is a multimedia file, such as a multimedia message file. Said markup language is SMIL language, and said tag is based on RDF (Resource Description Framework) language.

The present invention also provides an editing method for a markup language-based file, which includes the object with the recommended editing tag. Firstly, prompt user said object, which is recommended for editing; secondly, accept the user's choice for the prompted object, and accept the user's modification to the selected object; lastly, generate a new markup language-based file according to the modified object. Said file is a multimedia file, such as a multimedia message file. Said markup language is SMIL language, and said recommended editing tag is based on RDF (Resource Description Framework) language.

The present invention also provides an editing device for editing a markup language-based file, which includes the object with the recommended editing tag. The editing device includes a prompting means, a choosing means, a modifying means and a generating means. The prompting means is used for prompting the user said object, which is recommended for editing; the choosing means is used for receiving the user's choice to the prompted object; the modifying means is used for receiving the user's modification to the chosen object; and the generating means is used for generating a new markup language-based file according to the modified object.

The present invention also provides a handheld apparatus which includes a display means, a input means, a sending means, a receiving means and an editing means. The editing means includes a prompting means, a choosing means, a modifying means and a generating means. The receiving means is used for receiving a file, which is based on a markup language and contains the object with the recommended editing tag. The prompting means is used for prompting the user said object, which is recommended for editing; the choosing means is used for receiving the users choice to the prompted object; the modifying means is used for receiving the user's modification to the chosen object; and the generating means is used for generating a new markup language-based file according to the modified object.

Said file is a multimedia file, such as a multimedia message file. Said markup language is SMIL language, and said tag is based on RDF (Resource Description Framework) language.

The present invention adds some corresponding tags to a multimedia message file, indicating that these objects are recommended, by predicting the objects that mobile phone users often need to modify in the producing phase of the multimedia message file. When a normal mobile phone user receives a multimedia message generated according to the above method on his phone, he can conveniently find the objects he wants to modify from many objects in the multimedia message file, so that he can modify these objects and generate a personalized multimedia message he wants. Therefore, the present invention greatly facilitates the operations of the normal mobile phone users on multimedia messages, and can reduce the requirement of their mastering level of the computer language, and the operations on multimedia messages can also be conveniently made even on a handheld apparatus with restricted resources.

By reference to the below descriptions incorporated with drawings and claims, other objects and achievements of present invention are obvious, and a comprehensive understanding of the present invention can be gained.

### BRIEF DESCRIPTION OF THE DRAWINGS

The present invention is elaborately explained through the embodiments and by reference to the drawings, in which:

FIG. 1 is a systematic block diagram of the generating means for a markup language-based file according to an embodiment of the present invention;

FIG. 2 is a schematic diagram of the presenting of a multimedia message;

FIG. 3 is a flow chart of generating a markup language-based file according to an embodiment of the present invention;

FIG. 4 is a systematic block diagram of the apparatus for editing a markup language-based file according to another embodiment of the present invention;

FIG. 5 is a flow chart of editing a markup language-based file according to another embodiment of the present invention.

Throughout the drawings, the same reference number refers to the similar or same feature and function.

### DETAILED EMBODIMENTS OF THE INVENTION

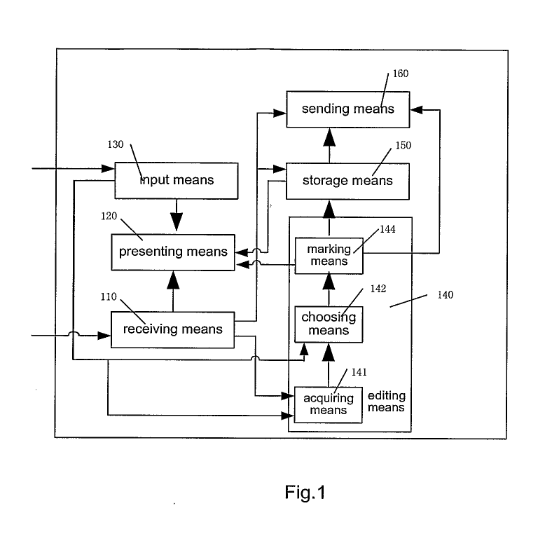

FIG. 1 is a systematic block diagram of the generating device for a markup language-based file according to an embodiment of the present invention; Device 100 includes an editing means 140, which includes an acquiring means 141, a choosing means 142 and a marking means 144.

Device 100 further includes a receiving means 110, a presenting means 120, an input means 130, a storage means 150 and a sending means 160. Device 100 may be a part of a computer, especially a personal PC (not shown in Figure), in which some means' functions can be implemented through software. The above means included in apparatus 100 can be implemented through many present means by those of skilled in the art, as long as they can be composed together and achieve the function of the present invention.

The receiving means 110 is used for receiving a multimedia message file, which is based on a markup language, such as SMIL language.

The presenting means 120 is used for presenting a multimedia message to the user, and showing the user's input message from input means 130. The multimedia message can come from receiving means 110, editing means 140, or even storage means 150.

The input means 130 is used for receiving the user's input message, and transfers the input message to the presenting means 120 and/or editing means 140.

The editing means 140 is used for generating a markup language-based file, which contains object with the recommended editing tag. The acquiring means 141 is used for acquiring an initial file, which is based on said markup language and includes at least two objects. The initial file can originate from a multimedia message file received by the receiving means 110, or originate from the input of the user (the producer of the multimedia message) received by the input means 130, for example, the user is creating a new multimedia message file from scratch. The choosing means 142 is used for receiving the user's choice of one object from said at least two objects, and the user chooses from the received multimedia message files, and finds out a/some object(s) for recommending that the future user (the user of the multimedia message) would need to edit. The marking means 144 is used for marking the chosen object to be recommended, and inserting some corresponding recommended editing tags in the multimedia message file, and these tags can be used for prompting the future user that these objects are editable.

The storage means 150 is used for saving a multimedia message file, preparing for future presenting or sending.

The sending means 160 is used for sending out a multimedia message file through wire or wirelessly, and the multimedia message file can come from editing means 140, storage means 150, or from receiving means 110.

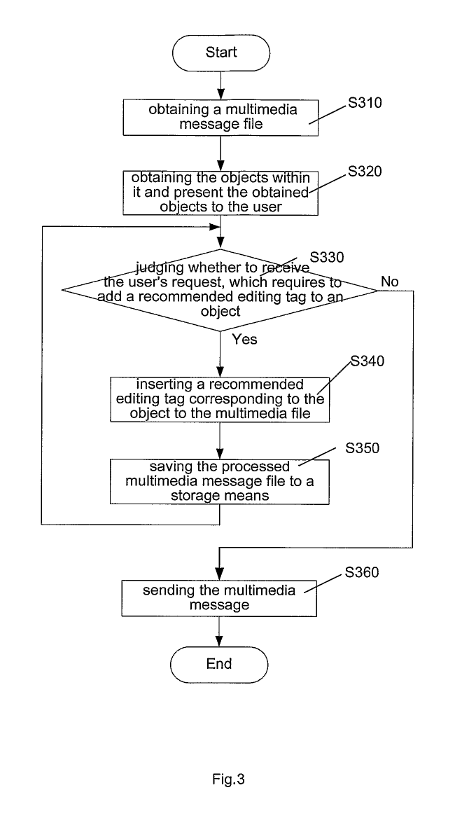

The running process of apparatus 100 is illustrated in FIG. 3 below.

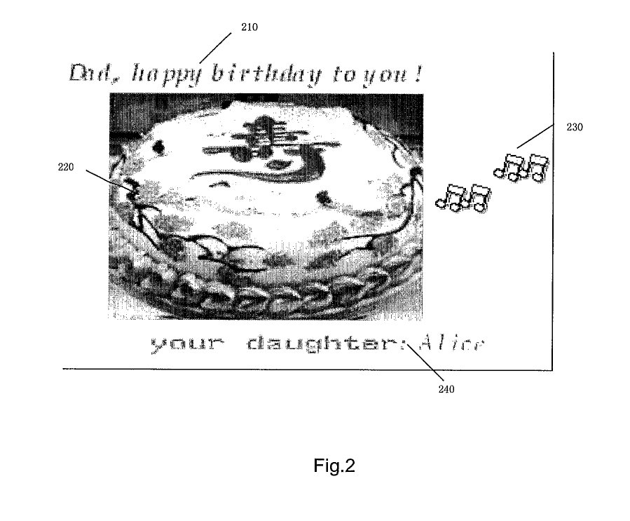

FIG. 2 is a schematic diagram of the presenting of a multimedia rnessage. The multimedia message includes a text object 210, an image object 220, an audio object 230 and a text object 240.

The content of the text object 210 is “Dad, happy birthday to you!”, used for expressing greeting. The content of the text object 240 is “your daughter: Alice”, used for ind icating signature.

The content of image object 220 is a picture of cake, and the object can be replaced by a video object, such as an on scene video clip of some famous singer singing “Happy Birthday”. The content of audio object 230 is a 20 seconds music clip, which content is the sound of singing song “Happy Birthday”.

The corresponding SMIL file of the multimedia message is as follow:

<smil xmlns=“http://www.w3.org/2001/SMIL20/Language”>
<head>

<layout>

<root-layout width=“320” height=“240”/>
<region id=“Title” left=“0” top=“0” width=“320” height=“30”

z-index=“1”/>

<region id=“Photo” left=“0” top=“30” width=“320”

height=“180”
z-index=“1”/>

<region id=“Sign” left=“0” top=“210” width=“320”

height=“30”
z-index=“1”/>

</layout>

</head>
<body>

<par>

<img id=“Cake” src=“cake.png” region=“Photo” />
<text id=“My Hello” src=“hello.txt” region=“Title” />
<audio id=“Happy Birthday” src=“happy birthday.mp3”
dur=“20s”/>
<text id=“MySignature” src=“mysignature.txt” region=“Sign”

begin=“20s”/>

</par>

</body>
</smil>

In the below embodiment, the present invention will be illustrated with the multimedia message file.

FIG. 3 is a flow chart of generating a markup language-based file according to an embodiment of the present invention. The markup language-based file can be a multimedia message file based on SMIL language. The process mostly applies on the editing means with relatively plentiful resources, such as personal PC. The process can add the recommended editing tag to one/some of the object(s) in the multimedia message according to the prediction of demands of the future user (the user of the multimedia message), so that these objects can be conveniently found when editing the file in future.

First, obtain a multimedia message file (step S310), which contains several objects. In the markup language based files, these objects may exist in the form of data segment. Due to the rapid development of data transferring technology (through wire or wirelessly), a multimedia message file may be transferred can contain more and more objects, and the amount can be hundreds or thousands, or even more. For the sake of simplicity and explaining easily, the embodiment still uses the multimedia message containing four objects said in FIG. 2 as example.

After receiving the multimedia message file, obtain the objects within it and present the obtained objects to the user (except that marked specially in the process, all of the user refer to the producer of the multimedia message) (step S320). The objects that can present in the embodiment have: a text object expressing the greeting, an image object with cake picture, an audio object with a music clip, and a text object indicating the signature. The acquiring process can be achieved using the existing producing tools, such as GriNS from the Netherland company Oratrix, RealSlideShow from the US company RealNetworks, and so on.

Then, judge whether to receive the user's request, which requires to add a recommended editing tag to an object(step S330), if the result of judgment is positive, insert a recommended editing tag corresponding to the object to the multimedia file (step S340).

In the embodiment, the user requires to add a recommended editing tag to the object expressing greeting, and the recommended editing tags can be some descriptive information, for example, adding some meta and metadata elements in the SMIL file head element, and the grammar of the meta element can be as below:
<meta name=“EditableObject” Content=“Object_id”/>

According to the grammar, above recommended editing tag can be described as below:
<meta name=“EditableObject” Content=“My Hello”/>

Next, save the processed multimedia message file to a storage means (step S350), and return to step S330 and judge whether to receive the user's another request, which requires to add a recommended editing tag to another object, if the result of judgment is positive, insert a recommended editing tag corresponding to the object to the multimedia file. In the embodiment, the user requires to add a recommended editing tag to the object indicating signature, which can be described as below:
<meta name=“EditableObject” Content=“MySignature”/>

Last, if the result of judgment in step S330 is negative, send the multimedia message (step S360), and end the whole process. Certainly, in above process, the step S350 can be skipped and send the processed multimedia message directly.

In above step S330, the received user's request can be the user's prediction of the objects that may need to be modified according to the future user of the message, such as the forwarding person, and find out a part of objects from many objects in the message and add the recommended editing tag to these objects, in this way, the future user of the message may conveniently find the objects he wants to modify from many objects in the message, and thus facilitate the user to edit the multimedia message and forward the multimedia message.

In above step S340, the inserted recommended editing tag is metadata element descriptive information, which may also be carried out through RDF (Resources Description Framework). RDF is a metadata descriptive language based on XML, and gets the support of the SMIL2.0 metadata information module. After applying RDF description framework, the multimedia message file of the embodiment can be described below, wherein the black parts are recommended editing tag.

<smil xmlns=“http://www.w3.org/2001/SMIL20/Language”>
<head>

<metadata id=“meta-rdf”>

<!-RDF Namespace Declaration -->

<rdf:RDF

xmlns:rdf=http://www.w3.org/1999/02/22-rdf-syntax-ns#
xmlns:rdfs =

http://www.w3.org/TR/1999/PR-rdf-schema-19990303#

xmlns:dc = http://purl.org/metadata/dublin_core#
xmlns:mmsmetadata = “http://www.3gpp.org/... /mms-ns#”>

<!-- Metadata about the Mutable Media Object for MMS -->
<rdf:Description about=“this document”

dc:Title=“A MMS Template”
dc:Description=“A MMS Template with MMO Embedded”
dc:Publisher=“W3C”
dc:Date=“2003-09-02”
dc:Rights=“Copyright 2003 Philips”
dc:Format=“text/smil” >

<rdf:Description about=“#MyHello ”

dc:Title=“Hello Message”
dc:Description=“A Editable Media Object”

dc:Language=“en ”>

<mmsmetadata:MMOEditable=“true” PromptWord=“Say

hello here” />

</rdf:Description>
<rdf:Description about=“#MySignature ”

dc:Title=“Signature”
dc:Description=“A Editable Media Object”
dc:Language=“en ”>

<mmsmetadata:MMOEditable=“true” PromptWord=“Leave

your signature here” />

</rdf:Description>

<mmsmetadata:MMOAuthoringSequence>

<rdf:Seq>

<rdf:li Resource=“#MyHello” />
<rdf:li Resource=“#MySignature” />

</rdf:Seq>

</mmsmetadata:MMOAuthoringSequence>

</rdf:Description>

</rdf:RDF>

</metadata>
<layout>

<root-layout width=“320” height=“240”/>
<region id=“Title” left=“0” top=“0” width=“320” height=“30”

z-index=“1”/>

<region id=“Photo” left=“0” top=“30” width=“320” height=“180”

z-index=“1”/>

<region id=“Sign” left=“0” top=“210” width=“320” height=“30”

z-index=“1”/>

</layout>

</head>
<body>

<par>

<img id=“Cake” src=“cake.png” region=“Photo” />
<text id=“MyHello” src=“hello.txt” region=“Title” />
<audio id=“Birthday” src=“birthday.mp3” dur=“20s”/>
<text id=“MySignature” src=“mysignature.txt” region=“Sign”

begin =“20s”/>

</par>

</body>
wherein:

<rdf:Seq>

<rdf:li Resource=“#MyHello” />
<rdf:li Resource=“#MySignature” />

</rdf:Seq>

is used for indicating when editing the multimedia message in the future, the below recommended order can be used to prompt the user, that is, first prompting the user to edit the greeting object, then prompting the user to edit the signature object.

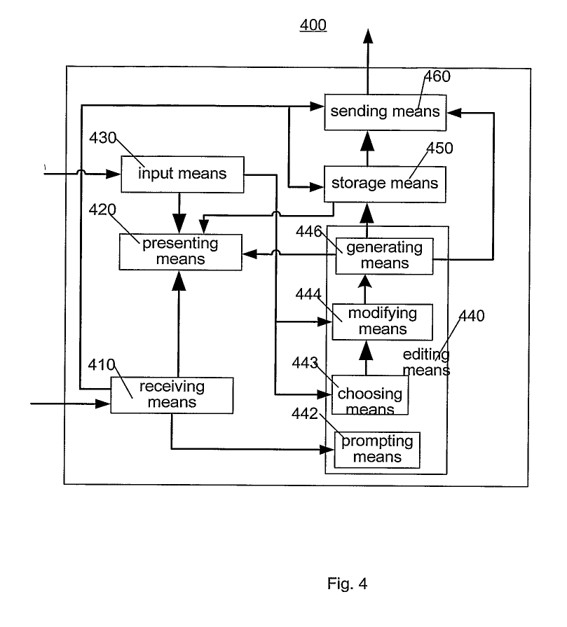

FIG. 4 is a systematic block diagram of the apparatus for editing a markup language-based file according to another embodiment of the present invention. The apparatus 400 includes an editing means 440, which includes a prompting means 442, a choosing means 443, an modifying means 444 and a generating means 446. The apparatus 400 also includes a receiving means 410, a presenting means 420, an input means 430, a storage means 450 and a sending means 460.

The apparatus 400 can be a part of handheld apparatus, such as mobile phone, in which functions of some means can be implemented through software. The above means included in apparatus 400 can be implemented through many existing means by those of skilled in the art, as long as they can be composed together and achieve the function of the present invention.

The receiving means 410 is used for receiving a multimedia message file, which is based on a markup language, such as SMIL language, and the file includes the objects with the recommended editing tag.

The presenting means 420 is used for presenting a multimedia message to the user, and presenting the user's input message from input means 430. The multimedia message can come from receiving means 410, editing means 440, or storage means 450.

The input means 430 is used for receiving the user's input message, and transferring the input message to the presenting means 420 and/or editing means 440.

The editing means 440 is used for editing a markup language-based file, which contains objects with the recommended editing tag. The file can originate from a multimedia message file the receiving means 410 received. The prompting means 442 is used for prompting the user the recommended objects according to the recommended editing tag contained in the file. The choosing means 443 is used for receiving the user's choice of the prompted objects. The modifying means 444 is used for accepting the modification of the objects chosen by the user. And the generating means 446 is used for generating a new markup language-based file according to the modified objects.

The storage means 450 is used for saving a multimedia message file for presenting or sending in the future.

The sending means 460 is used for sending out a multimedia message file through wire or wirelessly, and the multimedia message file can come from the editing means 440, storage means 450, or from the receiving means 410.

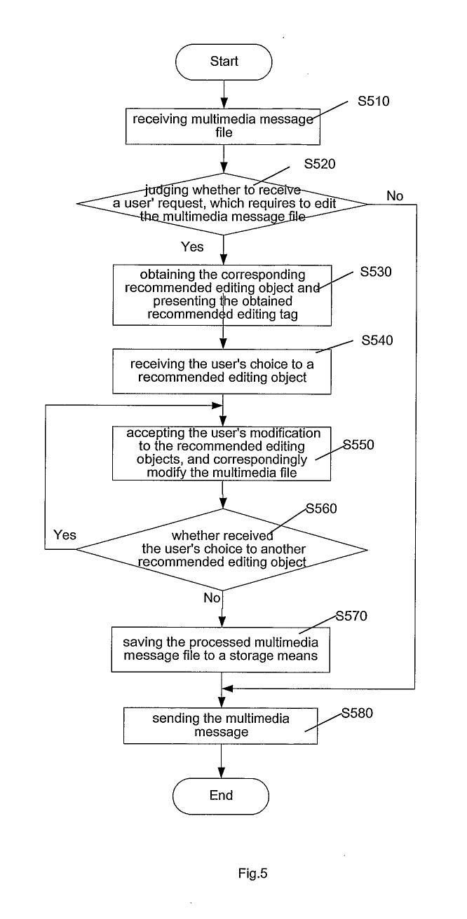

The running process of the apparatus 400 is illustrated in FIG. 5 below.

FIG. 5 is a schematic flow chart of editing a rnarkup language-based file according to another embodiment of the present invention. The markup language-based file can be a multimedia message file based on SMIL language, and the file contains some recommended editing tags and their corresponding objects. The process mostly applies on resource restricted handheld apparatus, such as mobile phone. The process can conveniently find the corresponding object according to the recommended editing tag inserted in the file in advance.

First, receive a multimedia message file (step S510), which contains several objects and one or more of these objects has(have) the corresponding recommended editing tag(s). In markup language based file, the object may exist in the form of data segment. The embodiment uses the multimedia message obtained after processing through FIG. 3 process as an example, and the multimedia message contains 4 objects, in which 2 of them have the recommended editing tag.

After receiving the multimedia message file, judge whether to receive a user' request, which requires to edit the multimedia message file (step S520), if the result of judgment is negative, send the multimedia message (step S580), and end the whole process. If the result of judgment is positive, obtain the corresponding recommended editing object according to the recommended editing tag contained in the multimedia message file and present the obtained recommended editing tag to the user (step S530). In the embodiment, there are 2 presented recommended editing objects. One is the text object for expressing greeting and the other is the text object for indicating the signature.

Then, receive the user's choice to a recommended editing object (step S540), for example, the user wants to forward the multimedia message to his friend Tom, so he needs to choose the object expressing greeting.

After the recommended editing object has been chosen, accept the user's modification to the recommended editing objects (step S550), for example, receive the user's input “Hi, Tom, Happy Birthday to You!”, and change the content of “hello.txt” in
<text id=“MyHello” src=“hello.txt” region=“Title”/>
from “Dad, happy birthday to you!” to “Hi, Tom, Happy Birthday to You!” according to the input.

Next, judge whether received the user's choice to another recommended editing object (step S560), if the result of judgment if positive, return to the step S550 and accept the user's modification to the recommended editing object, and correspondingly modify the multimedia message file. In the embodiment, choose the object indicating signature, and receive the user's input “Your old Friend: Richard”, and change the content of “mysignature.txt” in

<text id=“MySignature” src=“mysignature.txt” region=“Sign”

begin=“20s”/>

from “your daughter: Alice” to “Your old Friend: Richard” according to the input.

Last, if the result of judgment in step S560 is negative, save the processed multimedia message file to a storage means (step S570), and send the multimedia message (step S580). Certainly, the step S570 can be skipped and send the processed multimedia message directly.

The above editing process can be implemented using DOM API (Document Object Model Application Program Interface) to make its user interface more user-friendly.

In above process, only part of objects in a multimedia message file may be presented for recommending, so from the viewpoint of resource restricted handheld apparatus, this may greatly reduce their dependence on resources; from the viewpoint of the user, because of no need to choose and process all the objects one by one, the operations on these means are relatively simple and easy to learn, especially to the multimedia message containing plenty of objects, the advantages of the present invention is particularly obvious.

In the embodiment of the present invention, some of objects in the multimedia file are attached with recommended editing tag, and the rest objects can be processed somehow so that they become un-editable objects and thus realizes the aim of right protection, for example, a TV station's logo in a multimedia TV program can be processed to un-editable object.

Certainly, the rest objects' property can also be kept as editable as in the prior art, only when editing the multimedia message, first present the object containing the recommended editing tag as said in present invention, then prompt the user whether he needs to further modify the rest of objects, if the user's answer is yes, present these objects to user.

Furthermore, the objects that can be attached with recommended editing tag are not limited to the text objects in the embodiment of the present invention. They can be any object in the multimedia message file, but it's better that they are the objects the multimedia message user would need to edit and relatively easy-to-edit.

In addition, in the present invention, the embodiment uses the SMIL language as the example, in fact, for any markup language, such as XHTML, SVG, the method and apparatus presented in the invention can be applied.

While this invention has been described in terms of preferred embodiments, it will be apparent to those skilled in the art that substitutes, modification and changes can be applied to the processes described herein. Therefore, all such substitutes, modifications and changes are deemed to be within the spirit and scope of the invention as it is set out in the appended claims.

What is claimed is:

1. A method for creating a file based on a markup language, comprising the steps of:
obtaining an initial file that is based on said markup language and includes at least two objects;
receiving a user's choice of one of the at least two objects; and
marking the selected object as one being recommended, making it be preferentially recommended when editing the created file in future.

2. The method according to claim 1, wherein the marking step is a step of inserting a mark into the file.

3. The method according to claim 2, wherein said mark is based on RDF (Resources Description Framework) language.

4. The method according to claim 1, further comprising a step of: sending the created file.

5. The method according to claim 1, wherein said file is a multimedia information file.

6. The method according to claim 1, wherein said markup language is XML (eXtensible Markup Language).

7. The method according to claim 1, wherein said markup language is SMIL (Synchronized Multimedia Integration Language).

8. A method for editing a file based on the markup language, the file including objects with recommended editing marks, comprising the steps of:
a. giving user a prompt on the objects that are recommended to be edited;
b. receiving the user's choice of the prompted objects;
c. receiving the user's modification of the selected object; and
d. creating a new file based on the markup language according to the modified object.

9. The method according to claim 8, further comprising a step of receiving said file to be edited.

10. The method according to claim 8, further comprising the step of: sending the created file.

11. The method according to claim 8, wherein said file is a multimedia information file.

12. The method according to claim 8, wherein said markup language is SMIL (Synchronized Multimedia Integration Language).

13. The method according to claim 8, wherein said recommended editing marks are based on RDF (Resources Description Framework) language.

14. The method according to claim 8, wherein the objects with the recommended editing marks are a part of all objects in said file.

15. An apparatus for creating a file based on the markup language, comprising:
obtaining means for obtaining an initial file that is based on said markup language and includes at least two objects;
selecting means for receiving a user's choice of one of said at least two objects; and
marking means for marking the selected object as one being commended, making it be preferentially recommended when editing the created file in future.

16. The apparatus according to claim 15, wherein the marking means is used to insert a mark into the file.

17. The apparatus according to claim 15, wherein said file is a multimedia information file based on SMIL (Synchronized Multimedia Integration Language).

18. An apparatus for editing a file based on the markup language, the file including objects with recommended editing marks, comprising:
prompting means for giving user a prompt on the objects that are recommended to be edited;
selecting means for receiving a user's choice of the prompted objects;
modifying means for receiving a user's modification of the selected object; and creating means for creating a new file based on the markup language according to the modified object.

19. The apparatus according to claim 18, further comprising receiving means for receiving said file to be edited.

20. The apparatus according to claim 18, wherein said file is a multimedia information file based on SMIL (Synchronized Multimedia Integration Language).

21. A portable apparatus, comprising:
showing means;
inputting means;
sending means;
receiving means for receiving a file that is based on a markup language and includes objects with recommended editing marks; and
editing means, including:
prompting means for giving user a prompt on the objects that are recommended to be edited;
selecting means for receiving a user's choice of the prompted objects;
modifying means for receiving a user's modification of the selected object; and
creating means for creating a new file based on the markup language according to the modified object;
wherein the prompting means is connected to the receiving device, the showing means and the selecting means, the selecting means is connected to the inputting means and the modifying means, the modifying means is connected to the inputting means and the creating means, the creating means is connected to the showing device and the sending device.

22. The apparatus according to claim 21, wherein said markup language is SMIL (Synchronized Multimedia Integration Language) and said file is a multimedia information file.
